(19) United States
(12) Patent Application Publication
(10) Pub. No.: US 2018/0032914 A1
(43) Pub. Date: Feb. 1, 2018

(54) MACHINE LEARNING DATA ANALYSIS SYSTEM AND METHOD

(71) Applicant: Gamalon, Inc., Cambridge, MA (US)

(72) Inventors: BENJAMIN W. VIGODA, Winchester, MA (US); Cameron E. Freer, Cambridge, MA (US); Charith Srian Peris, Boston, MA (US); Daniel F. Ring, San Francisco, CA (US); Jacob E. Neely, Watertown, MA (US); Jeffrey Finkelstein, Cambridge, MA (US); Martin Blood Zwirner Forsythe, Cambridge, MA (US); Matthew C. Barr, Malden, MA (US)

(21) Appl. No.: 15/660,842

(22) Filed: Jul. 26, 2017

Related U.S. Application Data
(60) Provisional application No. 62/366,904, filed on Jul. 26, 2016.
(60) Provisional application No. 62/366,898, filed on Jul. 26, 2016.

(51) Int. Cl. G06N 99/00; G06N 3/08; G06F 17/30

(52) U.S. Cl. CPC G06N 99/005; G06F 17/30867; G06N 3/08

(57) ABSTRACT

A computer-implemented method, computer program product and computing system for defining a model that includes a plurality of variables. At least one variable of the plurality of variables is conditioned based, at least in part, upon a conditioning command received from a user, thus defining a conditioned variable. The model is inferenced based, at least in part, upon the conditioned variable.

### RELATED APPLICATION(S)

This application claims the benefit of U.S. Provisional Application No. 62/366,904, filed on 26 July 2016, and U.S. Provisional Application No. 62/366,898, filed on 26 Jul. 2016; the contents of which are incorporated herein by reference.

### TECHNICAL FIELD

This disclosure relates to data processing systems and, more particularly, to machine learning data processing systems.

### BACKGROUND

Businesses may receive and need to process content that comes in various formats, such as fully-structured content, semi-structured content, and unstructured content. Unfortunately, processing content that is not fully-structured (namely content that is semi-structured or unstructured) may prove to be quite difficult due to e.g., variations in formatting, variations in structure, variations in order, variations in abbreviations, etc.

Accordingly, the processing of content that is not fully-structured (e.g., semi-structured or unstructured content) may require extensive manual processing and manual reviewing in order to achieve a satisfactory result.

### SUMMARY OF DISCLOSURE

### Inference Pausing System

In one implementation, a computer-implemented method is executed on a computing device and includes defining a model that includes a plurality of variables. At least one variable of the plurality of variables is conditioned based, at least in part, upon a conditioning command received from a user, thus defining a conditioned variable. The model is inferenced based, at least in part, upon the conditioned variable.

One or more of the following features may be included. The conditioning command may define a selected value for the at least one variable. The conditioning command may define an excluded value for the at least one variable. The conditioning command may release control of the at least one variable. One or more candidate variables, chosen from the plurality of variables, may be identified to the user for potential conditioning selection. Conditioning at least one variable of the plurality of variables may include allowing the user to select the at least one variable from the one or more candidate variables.

In another implementation, a computer program product resides on a computer readable medium and has a plurality of instructions stored on it. When executed by a processor, the instructions cause the processor to perform operations including defining a model that includes a plurality of variables. At least one variable of the plurality of variables is conditioned based, at least in part, upon a conditioning command received from a user, thus defining a conditioned variable. The model is inferenced based, at least in part, upon the conditioned variable.

One or more of the following features may be included. The conditioning command may define a selected value for the at least one variable. The conditioning command may define an excluded value for the at least one variable. The conditioning command may release control of the at least one variable. One or more candidate variables, chosen from the plurality of variables, may be identified to the user for potential conditioning selection. Conditioning at least one variable of the plurality of variables may include allowing the user to select the at least one variable from the one or more candidate variables.

In another implementation, a computing system including a processor and memory is configured to perform operations including defining a model that includes a plurality of variables. At least one variable of the plurality of variables is conditioned based, at least in part, upon a conditioning command received from a user, thus defining a conditioned variable. The model is inferenced based, at least in part, upon the conditioned variable.

One or more of the following features may be included. The conditioning command may define a selected value for the at least one variable. The conditioning command may define an excluded value for the at least one variable. The conditioning command may release control of the at least one variable. One or more candidate variables, chosen from the plurality of variables, may be identified to the user for potential conditioning selection. Conditioning at least one variable of the plurality of variables may include allowing the user to select the at least one variable from the one or more candidate variables.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a distributed computing network including a computing device that executes a machine learning data analysis process according to an embodiment of the present disclosure;

FIG. 2 is a diagrammatic view of various tables;

FIG. 3 is a flowchart of another implementation of the machine learning data analysis process of FIG. 1 according to an embodiment of the present disclosure;

FIG. 4 is a diagrammatic view of various objects; and

FIG. 5 is a flowchart of another implementation of the machine learning data analysis process of FIG. 1 according to an embodiment of the present disclosure.

Like reference symbols in the various drawings indicate like elements.

### DETAILED DESCRIPTION OF THE PREFERRED EMBODIMENTS

System Overview

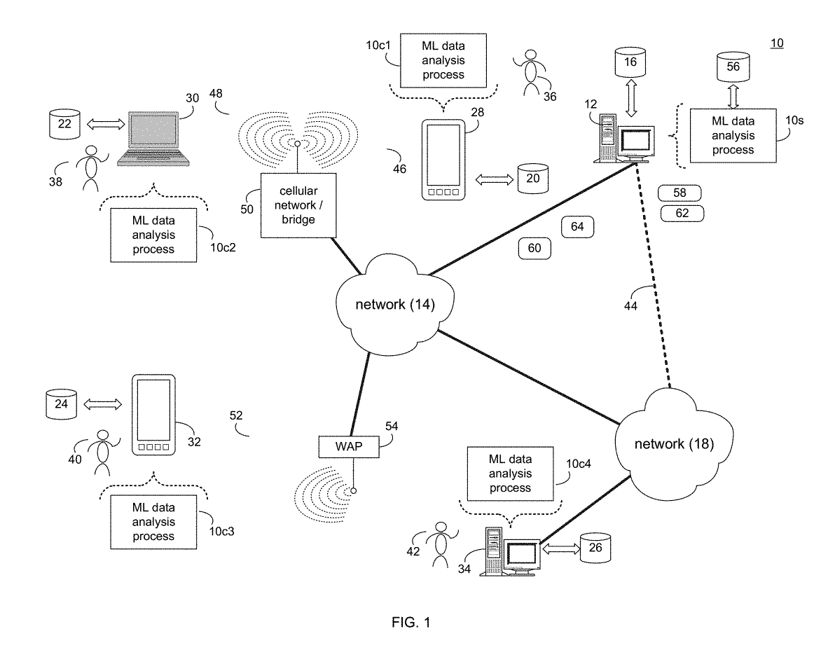

Referring to FIG. 1, there is shown machine learning data analysis process 10. Machine learning data analysis process 10 may be implemented as a server-side process, a client-side process, or a hybrid server-side/client-side process. For example, machine learning data analysis process 10 may be implemented as a purely server-side process via machine learning data analysis process 10s. Alternatively, machine learning data analysis process 10 may be implemented as a purely client-side process via one or more of client-side process 10c1, client-side process 10c2, client-side process 10c3, and client-side process 10c4. Alternatively still, machine learning data analysis process 10 may be implemented as a hybrid server-side/client-side process via data process 10s in combination with one or more of client-side process 10c1, client-side process 10c2, client-side process 10c3, and client-side process 10c4. Accordingly, machine learning data analysis process 10 as used in this disclosure may include any combination of machine learning data analysis process 10s, client-side process 10c1, client-side process 10c2, client-side process 10c3, and client-side process 10c4.

Machine learning data analysis process 10s may be a server application and may reside on and may be executed by computing device 12, which may be connected to network 14 (e.g., the Internet or a local area network). Examples of computing device 12 may include, but are not limited to: a personal computer, a laptop computer, a personal digital assistant, a data-enabled cellular telephone, a notebook computer, a television with one or more processors embedded therein or coupled thereto, a cable/satellite receiver with one or more processors embedded therein or coupled thereto, a server computer, a series of server computers, a mini computer, a mainframe computer, or a cloud-based computing network.

The instruction sets and subroutines of machine learning data analysis process 10s, which may be stored on storage device 16 coupled to computing device 12, may be executed by one or more processors (not shown) and one or more memory architectures (not shown) included within computing device 12. Examples of storage device 16 may include but are not limited to: a hard disk drive; a RAID device; a random access memory (RAM); a read-only memory (ROM); and all forms of flash memory storage devices.

Network 14 may be connected to one or more secondary networks (e.g., network 18), examples of which may include but are not limited to: a local area network; a wide area network; or an intranet, for example.

Examples of client-side processes 10c1, 10c2, 10c3, 10c4 may include but are not limited to a web browser, a game console user interface, or a specialized application (e.g., an application running on e.g., the Android™ platform or the iOS™ platform). The instruction sets and subroutines of client-side applications 10c1, 10c2, 10c3, 10c4, which may be stored on storage devices 20, 22, 24, 26 (respectively) coupled to client electronic devices 28, 30, 32, 34 (respectively), may be executed by one or more processors (not shown) and one or more memory architectures (not shown) incorporated into client electronic devices 28, 30, 32, 34 (respectively). Examples of storage device 16 may include but are not limited to: a hard disk drive; a RAID device; a random access memory (RAM); a read-only memory (ROM); and all forms of flash memory storage devices.

Examples of client electronic devices 28, 30, 32, 34 may include, but are not limited to, data-enabled, cellular telephone 28, laptop computer 30, personal digital assistant 32, personal computer 34, a notebook computer (not shown), a server computer (not shown), a gaming console (not shown), a smart television (not shown), and a dedicated network device (not shown). Client electronic devices 28, 30, 32, 34 may each execute an operating system, examples of which may include but are not limited to Microsoft Windows™, Android™, WebOS™, iOS™, Redhat Linux™, or a custom operating system.

Users 36, 38, 40, 42 may access machine learning data analysis process 10 directly through network 14 or through secondary network 18. Further, machine learning data analysis process 10 may be connected to network 14 through secondary network 18, as illustrated with link line 44.

The various client electronic devices (e.g., client electronic devices 28, 30, 32, 34) may be directly or indirectly coupled to network 14 (or network 18). For example, data-enabled, cellular telephone 28 and laptop computer 30 are shown wirelessly coupled to network 14 via wireless communication channels 46, 48 (respectively) established between data-enabled, cellular telephone 28, laptop computer 30 (respectively) and cellular network/bridge 50, which is shown directly coupled to network 14. Further, personal digital assistant 32 is shown wirelessly coupled to network 14 via wireless communication channel 52 established between personal digital assistant 32 and wireless access point (i.e., WAP) 54, which is shown directly coupled to network 14. Additionally, personal computer 34 is shown directly coupled to network 18 via a hardwired network connection.

WAP 54 may be, for example, an IEEE 802.11a, 802.11b, 802.11g, 802.11n, Wi-Fi, and/or Bluetooth device that is capable of establishing wireless communication channel 52 between personal digital assistant 32 and WAP 54. As is known in the art, IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

Machine Learning Data Analysis Process:

Assume for illustrative purposes that machine learning data analysis process 10 may be configured to process content (e.g., content 56). Examples of content 56 may include but are not limited to unstructured content; semi-structured content; and structured content.

As is known in the art, structured content may be content that is separated into independent portions (e.g., fields, columns, features) and, therefore, may have a pre-defined data model and/or is organized in a pre-defined manner. For example, if the structured content concerns an employee list: a first field, column or feature may define the first name of the employee; a second field, column or feature may define the last name of the employee; a third field, column or feature may define the home address of the employee; and a fourth field, column or feature may define the hire date of the employee.

Further and as is known in the art, unstructured content may be content that is not separated into independent portions (e.g., fields, columns, features) and, therefore, may not have a pre-defined data model and/or is not organized in a pre-defined manner. For example, if the unstructured content concerns the same employee list: the first name of the employee, the last name of the employee, the home address of the employee, and the hire date of the employee may all be combined into one field, column or feature.

Additionally and as is known in the art, semi-structured content may be content that is partially separated into independent portions (e.g., fields, columns, features) and, therefore, may partially have a pre-defined data model and/or may be partially organized in a pre-defined manner. For example, if the semi-structured data concerns the same employee list: the first name of the employee and the last name of the employee may be combined into one field, column or feature, while a second field, column or feature may define the home address of the employee; and a third field, column or feature may define the hire date of the employee.

In addition to being structured, unstructured or semi-structured, content 56 may be “noisy”, wherein “noisy” content may be substantially more difficult to process. As is known in the art, noisy content may be content that lacks the consistency to be properly and/or easily processed.

For example, unstructured content (and to a lesser extent semi-structured content) may be considered inherently noisy, since the full (or partial) lack of structure may render the unstructured (or semi-structured) content more difficult to process.

Further, structured content may be considered noisy if it lacks the requisite consistency to be easily processed. For example, if the above-described employee list is structured content that includes one field, column or feature to define the employee name, wherein the employee name is in a first name/last name format for some employees and in a last name/first name format for other employees, that content may be considered noisy even though it is structured. Further, if that same “structured” employee list defines the hire date for some employees in a mm/dd/yyyy format and for other employees in a dd/mm/yyyy format, that content may be considered noisy even though it is structured.

Accordingly, the processing of noisy unstructured content may be the most difficult content to process by machine learning data analysis process 10; while the processing of non-noisy, structured content may be the least difficult to process by machine learning data analysis process 10.

When processing content 56, machine learning data analysis process 10 may use probabilistic modeling to accomplish such processing, wherein examples of such probabilistic modeling may include but are not limited to discriminative modeling (e.g., a probabilistic model for only the content of interest), generative modeling (e.g., a full probabilistic model of all content), or combinations thereof.

As is known in the art, probabilistic modeling may be used within modern artificial intelligence systems (e.g., machine learning data analysis process 10), in that these probabilistic models may provide artificial intelligence systems with the tools required to autonomously analyze vast quantities of data.

Examples of the tasks for which probabilistic modeling may be utilized may include but are not limited to:
predicting media (music, movies, books) that a user may like or enjoy based upon media that the user has liked or enjoyed in the past;
transcribing words spoken by a user into editable text;
grouping genes into gene clusters;
identifying recurring patterns within vast data sets;
filtering email that is believed to be spam from a user's inbox;
generating clean (i.e., non-noisy) data from a noisy data set; and
diagnosing various medical conditions and diseases.

For each of the above-described applications of probabilistic modeling, an initial probabilistic model may be defined, wherein this initial probabilistic model may be iteratively modified and revised, thus allowing the probabilistic models and the artificial intelligence systems (e.g., machine learning data analysis process 10) to “learn” so that future probabilistic models may be more precise and may define more accurate data sets.

User-Teachable Metadata-Free ETL System

As discussed above, machine learning data analysis process 10 may be configured to process content (e.g., content 56), wherein examples of content 56 may include but are not limited to unstructured content, semi-structured content and structured content (that may be noisy or non-noisy).

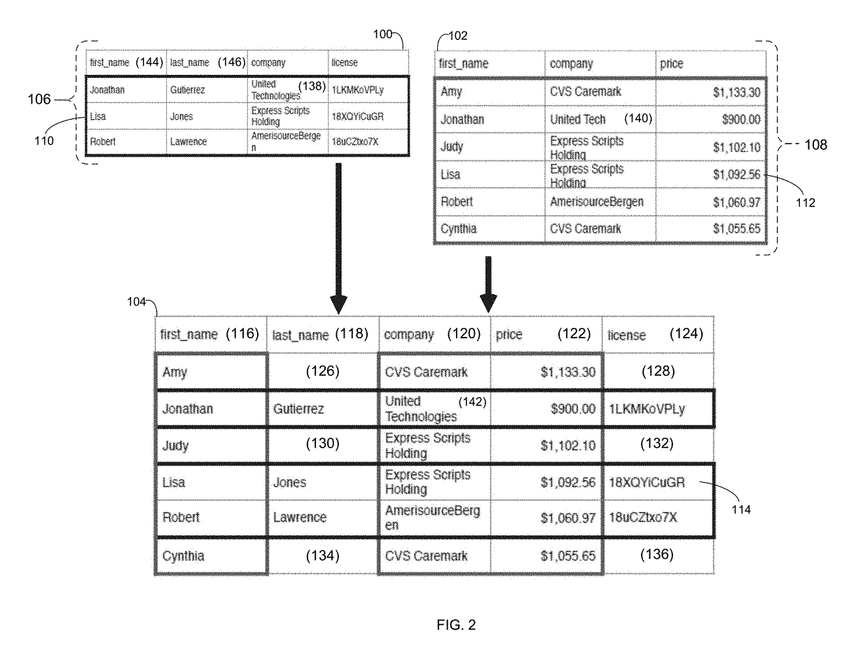

Referring also to FIG. 2, assume for this example that content 56 includes two pieces of content (e.g., table 100 and table 102), wherein the content of table 100 and the content of table 102 may be combined by machine learning data analysis process 10 to form table 104.

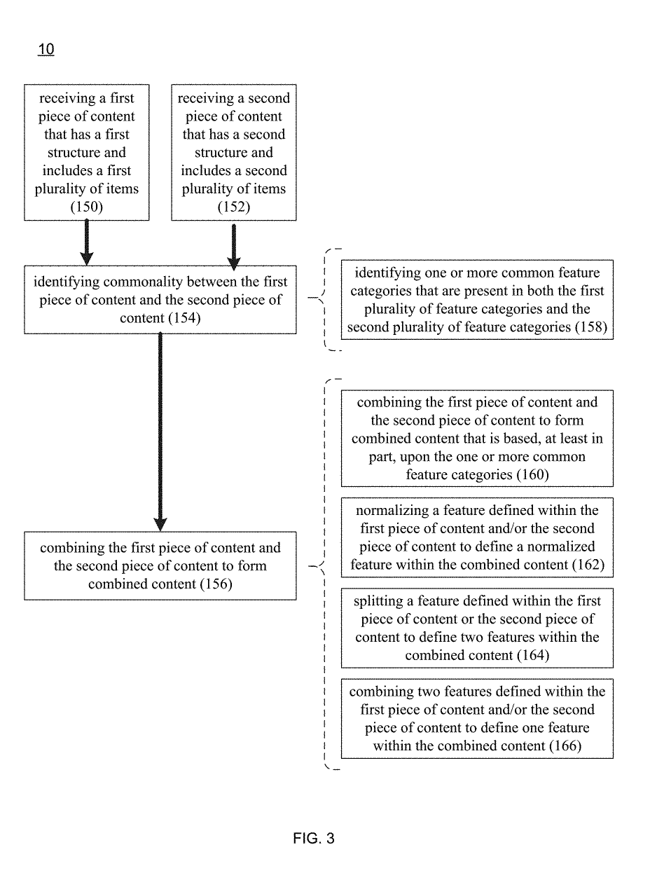

Referring also to FIG. 3, machine learning data analysis process 10 may receive 150 a first piece of content (e.g., table 100) that has a first structure and includes a first plurality of items (e.g., plurality of items 106). Accordingly and in this example, the structure of table 100 (i.e., the first structure) may include a first plurality of feature categories (e.g., “first_name”, “last_name”, “company” and “license”).

Machine learning data analysis process 10 may also receive 152 a second piece of content (e.g., table 102) that has a second structure and includes a second plurality of items (e.g., plurality of items 108). Accordingly and in this example, the structure of table 102 (i.e., the second structure) may include a second plurality of feature categories (e.g., “first_name”, “company”, and “price”).

Machine learning data analysis process 10 may identify 154 commonality between the first piece of content (e.g., table 100) and the second piece of content (e.g., table 102) and may combine 156 the first piece of content (e.g., table 100) and the second piece of content (e.g., table 102) to form combined content (e.g., table 104) that is based, at least in part, upon the identified commonality.

When identifying 154 commonality between the first piece of content (e.g., table 100) and the second piece of content (e.g., table 102), machine learning data analysis process 10 may identify 158 one or more common feature categories that are present in both the first plurality of feature categories (e.g., “first_name”, “last_name”, “company” and “license”) of the first piece of content (e.g., table 100) and the second plurality of feature categories (e.g., “first_name”, “company”, and “price”) of the second piece of content (e.g., table 102).

Since the first piece of content (e.g., table 100) and the second piece of content (e.g., table 102) both include the feature categories “first_name” and “company”, machine learning data analysis process 10 may identify 158 feature categories “first_name” and “company” as common feature categories that are present in both the first plurality of feature categories of the first piece of content (e.g., table 100) and the second plurality of feature categories of the second piece of content (e.g., table 102).

As discussed above, once machine learning data analysis process 10 identifies 154 commonality between the first piece of content (e.g., table 100) and the second piece of content (e.g., table 102), machine learning data analysis process 10 may combine 156 the first piece of content (e.g., table 100) and the second piece of content (e.g., table 102) to form combined content (e.g., table 104) that is based, at least in part, upon the identified commonality, which may include combining 160 table 100 and table 102 to form table 104 that is based, at least in part, upon the one or more common feature categories (e.g., feature categories “first_name” and “company”) that were identified above.

Accordingly, machine learning data analysis process 10 may combine 160 table 100 and table 102 to form table 104 that includes five feature categories (namely “first_name”, “last_name”, “company”, “price” and “license”). For example, machine learning data analysis process 10 may combine 160 item 110 within table 100 (that contains features “Lisa”, “Jones”, “Express Scripts Holding” and “18XQYiCuGR”) and item 112 within table 102 (that contains features “Lisa”, “Express Scripts Holding” and “$1,092.56”) to form item 114 within table 104 (that contains features “Lisa”, “Jones”. “Express Scripts Holding”, “$1,092.56” and “18XQYiCuGR”).

Accordingly and in this example, table 104 is shown to include “first_name” feature category 116, “last_name” feature category 118, “company” feature category 120, “price” feature category 122 and “license” feature category 124, wherein:
machine learning data analysis process 10 may obtain the information included within “first_name” feature category 116 from either table 100 or table 102 (as this is one of the commonalities between table 100 and table 102);
machine learning data analysis process 10 may obtain the information included within “company” feature category 120 from either table 100 or table 102 (as this is one of the commonalities between table 100 and table 102);
machine learning data analysis process 10 may obtain the information included within “last_name” feature category 118 from only table 100 (as table 102 does not include this information);
machine learning data analysis process 10 may obtain the information included within “price” feature category 122 from only table 102 (as table 100 does not include this information); and
machine learning data analysis process 10 may obtain the information included within “license” feature category 124 from only table 100 (as table 102 does not include this information).

As would be expected, table 104 will not include data (e.g., features) that were not included in either of tables 100, 102 or were undeterminable by machine learning data analysis process 10. For example:
cell 126 within table 104 is unpopulated because the last name of “Amy” is not defined within table 100 or table 102 and is undeterminable by machine learning data analysis process 10;
cell 128 within table 104 is unpopulated because the license of “Amy” is not defined within table 100 or table 102 and is undeterminable by machine learning data analysis process 10;
cell 130 within table 104 is unpopulated because the last name of “Judy” is not defined within table 100 or table 102 and is undeterminable by machine learning data analysis process 10;
cell 132 within table 104 is unpopulated because the license of “Judy” is not defined within table 100 or table 102 and is undeterminable by machine learning data analysis process 10;
cell 134 within table 104 is unpopulated because the last name of “Cynthia” is not defined within table 100 or table 102 and is undeterminable by machine learning data analysis process 10; and
cell 136 within table 104 is unpopulated because the license of “Cynthia” is not defined within table 100 or table 102 and is undeterminable by machine learning data analysis process 10.

As will be described below, when combining 156 table 100 and table 102 to form table 104, machine learning data analysis process 10 may normalize 162 content, split 164 content and/or combine 166 content. When performing such normalizing operations, splitting operations, and/or combining operations, machine learning data analysis process 10 may use the above-described probabilistic modeling to accomplish such operations, wherein examples of such probabilistic modeling may include but are not limited to discriminative modeling, generative modeling, or combinations thereof.

When combining 156 the first piece of content (e.g., table 100) and the second piece of content (e.g., table 102) to form combined content (e.g., table 104) that is based, at least in part, upon the identified commonality (e.g., feature categories “first_name” and “company”), machine learning data analysis process 10 may normalize 162 a feature defined within the first piece of content (e.g., table 100) and/or the second piece of content (e.g., table 102) to define a normalized feature within the combined content (e.g., table 104).

For example and with respect to “Jonathan”, cell 138 within table 100 is shown to include the feature “United Technologies” while cell 140 within table 102 is shown to include the feature “United Tech”. Accordingly, machine learning data analysis process 10 may normalize 162 the feature “United Technologies” within cell 138 of table 100 with the feature “United Tech” within cell 140 of table 102 to define a normalized feature (e.g., United Technologies”) within cell 142 of table 104.

When combining 156 the first piece of content (e.g., table 100) and the second piece of content (e.g., table 102) to form combined content (e.g., table 104) that is based, at least in part, upon the identified commonality (e.g., feature categories “first_name” and “company”), machine learning data analysis process 10 may split 164 a feature defined within the first piece of content (e.g., table 100) or the second piece of content (e.g., table 102) to define two features within the combined content (e.g., table 104).

For example, if one feature category within either table 100 or table 102 is a “name” category that defines the first name and the last name of an employee, machine learning data analysis process 10 may split 164 this single piece of information (e.g., first and last name) into two separate pieces of information that may be placed into two separate categories (e.g., “first_name” category 116 and “last_name” category 118) within table 104.

When combining 156 the first piece of content (e.g., table 100) and the second piece of content (e.g., table 102) to form combined content (e.g., table 104) that is based, at least in part, upon the identified commonality (e.g., feature categories “first_name” and “company”), machine learning data analysis process 10 may combine 166 two features defined within the first piece of content (e.g., table 100) and/or the second piece of content (e.g., table 102) to define one feature within the combined content (e.g., table 104).

For example, if one feature category within table 100 is “first_name” category 144 that defines the first name of an employee and another feature category within table 100 is “last_name” category 146 that defines the last name of an employee, machine learning data analysis process 10 may combine 166 these two pieces of information (e.g., first name and last name) into one single piece of information that may be placed into one category (e.g., a “name” category) within table 104.

While the above-discussion concerned the content of table 100 and the content of table 102 being combined by machine learning data analysis process 10 to form table 104, this is for illustrative purposes only and is not intended to be a limitation of this disclosure, as other configurations are possible. For example, one or more additional tables (not shown) may subsequently (or contemporaneously) be combined with table 100 and table 102 to form table 104.

Inference Pausing System

As discussed above, when processing the above-described content (e.g., content 56), machine learning data analysis process 10 may use probabilistic modeling to accomplish such processing, wherein examples of such probabilistic modeling may include but are not limited to discriminative modeling (e.g., a probabilistic model for only the content of interest), generative modeling (e.g., a full probabilistic model of all content), or combinations thereof. As discussed above, probabilistic modeling may be used within modern artificial intelligence systems (e.g., machine learning data analysis process 10) and may provide artificial intelligence systems with the tools required to autonomously analyze vast quantities of data.

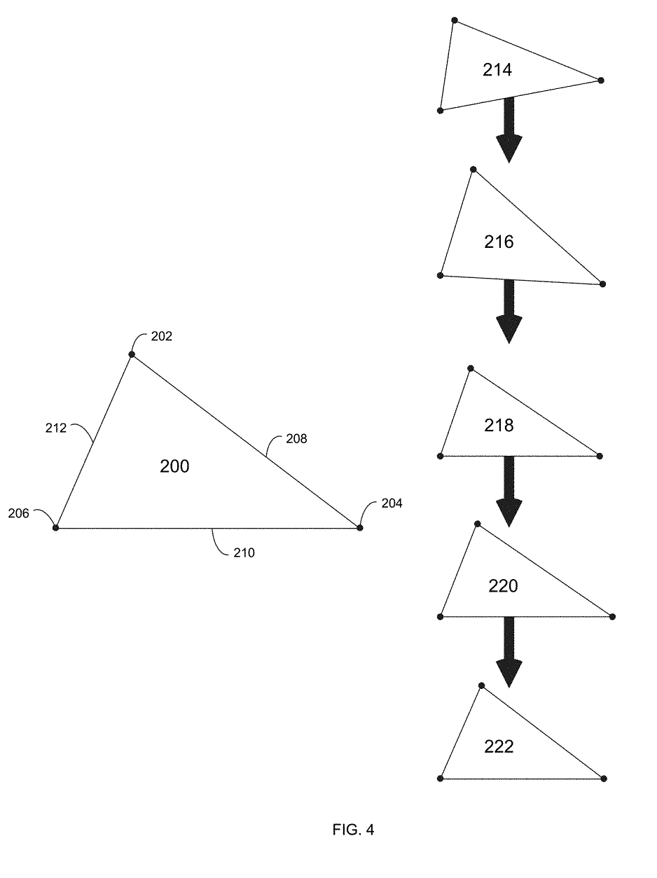

Referring also to FIG. 4, machine learning data analysis process 10 may define a probabilistic model (e.g., probabilistic model 58) for accomplishing a defined task. For example, assume that the defined task that probabilistic model 58 needs to accomplish is the copying of an image (e.g., triangle 200), wherein triangle 200 includes three data points (e.g., data points 202, 204, 206) having a line segment positioned between sets of data points. For example, line segment 208 may be positioned between data points 202, 204; line segment 210 may be positioned between data points 204, 206; and line segment 212 may be positioned between data points 206, 202.

As is known in the art, probabilistic models (such as probabilistic model 58) may include (or define) one or more variables that are utilized during the modeling (i.e., inferencing) process. Accordingly and for this simplified example, probabilistic model 58 may include three variables that define the location of each of data points 202, 204, 206, wherein the three variables may be repeatedly changed/adjusted during inferencing, resulting in the generation of many triangles. Each of these generated triangles may be compared to the desired triangle (e.g., triangle 200) to determine if the generated triangle is sufficiently similar to the desired triangle (e.g., triangle 200). Once a triangle is generated that is sufficiently similar to (in this example) triangle 200, the inferencing process may stop and the desired task may be considered accomplished.

According and when probabilistic model 58 is utilized to model triangle 200, the following abbreviated sequence of steps may occur:
machine learning data analysis process 10 may define an initial set of locations for data points 202, 204, 206 and line segments may be drawn between these data points, resulting in the generation of triangle 214;
machine learning data analysis process 10 may then compare triangle 214 to triangle 200 to determine whether triangle 214 is sufficiently similar to triangle 200 (this may be accomplished by assigning a matching score to triangle 214);
assuming triangle 214 is not sufficiently similar to triangle 200, machine learning data analysis process 10 may define a new set of locations for data points 202, 204, 206 and line segments may be drawn between these data points, resulting in the generation of triangle 216;
machine learning data analysis process 10 may then compare triangle 216 to triangle 200 to determine whether triangle 216 is sufficiently similar to triangle 200 (this may be accomplished by assigning a matching score to triangle 216);
assuming triangle 216 is not sufficiently similar to triangle 200, machine learning data analysis process 10 may define a new set of locations for data points 202, 204, 206 and line segments may be drawn between these data points, resulting in the generation of triangle 218;
machine learning data analysis process 10 may then compare triangle 218 to triangle 200 to determine whether triangle 218 is sufficiently similar to triangle 200 (this may be accomplished by assigning a matching score to triangle 218);
assuming triangle 218 is not sufficiently similar to triangle 200, machine learning data analysis process 10 may define a new set of locations for data points 202, 204, 206 and line segments may be drawn between these data points, resulting in the generation of triangle 220;
machine learning data analysis process 10 may then compare triangle 220 to triangle 200 to determine whether triangle 220 is sufficiently similar to triangle 200 (this may be accomplished by assigning a matching score to triangle 220);
assuming triangle 220 is not sufficiently similar to triangle 200, machine learning data analysis process 10 may define a new set of locations for data points 202, 204, 206 and line segments may be drawn between these data points, resulting in the generation of triangle 222; and
machine learning data analysis process 10 may then compare triangle 222 to triangle 200 to determine whether triangle 222 is sufficiently similar to triangle 200 (this may be accomplished by assigning a matching score to triangle 222).

Assume that upon comparing triangle 222 to triangle 200, machine learning data analysis process 10 determines that triangle 222 is sufficiently similar to triangle 200. Accordingly, machine learning data analysis process 10 may consider the task accomplished and the inferencing process may cease.

While the above-described example is explained to include three variables, this is for illustrative purposes only and is not intended to be a limitation of this disclosure, as other configuration are possible. For example, probabilistic models (such as probabilistic model 58) may include thousands of variables. And unfortunately, some of these variables may complicate the analysis process defined above, resulting in e.g., unmanageable data sets or unsuccessful conclusions (e.g., the desired task not being accomplished). Accordingly and as will be explained below, machine learning data analysis process 10 may be configured to allow a user to condition one or more variables within a probabilistic model (such as probabilistic model 58).

For example and when conditioning a variable within a probabilistic model (such as probabilistic model 58), machine learning data analysis process 10 may be configured to allow a user (e.g., user 36, 38, 40, 42) to:
define a selected value for a variable;
define an excluded value for a variable; and
release control of a variable.

Accordingly, assume that the modeling of triangle 200 is more complex due to numerous factors concerning the makeup of triangle 200 (e.g., the use of varying line thicknesses, the use of smoothing radii at the end points, the use of complex fill patterns within triangle 200, the use of color), resulting in probabilistic model 58 having thousands of variables. This drastic increase in variables within probabilistic model 58 may result in the inferencing of probabilistic model 58 becoming more complex and time consuming. Accordingly, machine learning data analysis process 10 may be configured to allow a user to condition one or more variables within a probabilistic model (such as probabilistic model 58) to better control the inferencing process.

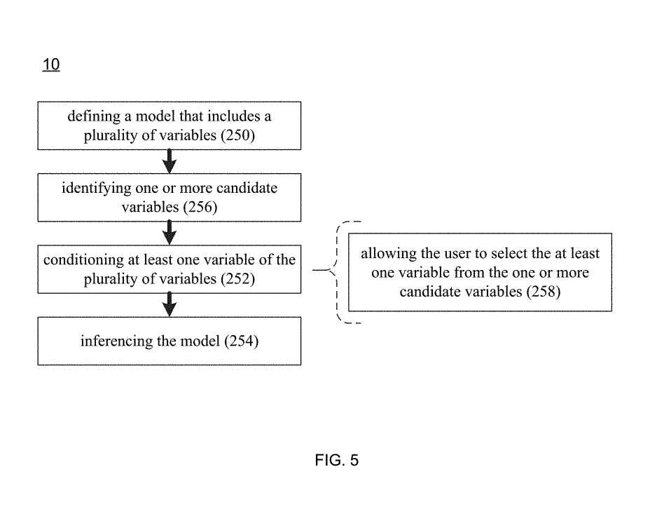

Referring also to FIG. 5 and continuing with the above-stated example, machine learning data analysis process 10 may define 250 a model (one such example of this model may include but is not limited to probabilistic model 58) that includes a plurality of variables (e.g., thousands of variables) and is designed to accomplish a desired task (such as the copying of triangle 200). As discussed above, each of these variables may be repeatedly changed/adjusted during inferencing, resulting in multiple rounds of inferencing and the generation of many triangles, which are compared to the desired triangle (e.g., triangle 200) to determine if a generated triangle is sufficiently similar to the desired triangle (e.g., triangle 200). As also discussed above, once a triangle is generated that is sufficiently similar to (in this example) triangle 200, the inferencing process may stop and the desired task may be considered accomplished.

While the following discussion concerns the above-referenced model being a probabilistic model, this is for illustrative purposes only and is not intended to be a limitation of this disclosure, as other types of models are possible and are considered to be within the scope of this disclosure.

In order to better control the inferencing process, machine learning data analysis process 10 may condition 252 at least one variable of the plurality of variables based, at least in part, upon a conditioning command (e.g., conditioning command 60) received from a user (e.g., user 36, 38, 40, 42) of machine learning data analysis process 10, thus defining a conditioned variable (e.g., conditioned variable 62).

Conditioning command 60 may be configured to allow a user (e.g., user 36, 38, 40, 42) of machine learning data analysis process 10 to:
define a selected value for a variable;
define an excluded value for a variable; and
release control of a variable.

When defining a selected value for a variable, machine learning data analysis process 10 may allow a user (e.g., user 36, 38, 40, 42) to specify a specific value for a variable (e.g., the location of a data point must be X, the thickness of a line must be Y, the radius of a curve must be Z). This may be accomplished via e.g., a drop down menu, one or more radio buttons or a data entry field rendered by machine learning data analysis process 10.

When defining an excluded value for a variable, machine learning data analysis process 10 may allow a user (e.g., user 36, 38, 40, 42) to exclude a specific value for a variable (e.g., the location of a data point cannot be A, the thickness of a line cannot be B, the radius of a curve cannot be C). This may be accomplished via e.g., a drop down menu, one or more radio buttons or a data entry field rendered by machine learning data analysis process 10.

When releasing control of a variable, machine learning data analysis process 10 may allow a user (e.g., user 36, 38, 40, 42) to remove a limitation previously placed on a variable. For example, if a user (e.g., user 36, 38, 40, 42) previously defined (or excluded) a specific value for a variable, machine learning data analysis process 10 may allow the user to remove that limitation. This may be accomplished via e.g., a drop down menu, one or more radio buttons or a data entry field rendered by machine learning data analysis process 10.

While machine learning data analysis process 10 is described above as allowing a user (e.g., user 36, 38, 40, 42) to define a specific value for a variable via, e.g., a drop down menu, one or more radio buttons or a data entry field, this is for illustrative purposes only and is not intended to be a limitation of this disclosure, as other configurations are possible.

For example and when a variable is presented to the user as a candidate for conditioning 252, the candidate variable may be wrapped in a “madlib.” For example, a system that is finding the optimum airplane ticket for a user may contain a model of available airplane routes and user preferences for e.g., route, time of day, day of week, aisle versus window seat, etc.

Accordingly, machine learning data analysis process 10 may ask the user (e.g., verbally, textually, or pictorially) “Do you prefer a window seat or an aisle seat?” followed by e.g., a radio button for aisle and a radio button for window. The user may then click on one of these radio buttons. This selection by the user may then condition 252 the model so that inferencing can now proceed with finding flights that optimize the user's other preferences subject to availability, but always requiring an aisle seat in any answer that it finds.

Accordingly, the user does not experience the candidate variables for conditioning as naked choices, but instead they experience them as choices wrapped in a question or context that makes it clear to the user what question machine learning data analysis process 10 is asking of them.

Accordingly, the above-discussion represents a very general principle for building UI/UX for systems that are powered by any given model. Specifically, the model is developed, the variables to make visible to the user are chosen (this choice may be made by the system itself, the system user, or the system developer), and the interfaces are displayed, wherein these interfaces may display the progress of the inferencing procedure in those variables and/or allow the user to condition those variables to desired values.

By “skinning” this kind of interface in various ways, and choosing which variables to make visible to the user for feedback and/or for conditioning, applications may be quickly deployed that: are powered by models; display progress to the user concerning what the system is “thinking”; and allow the user to guide the behavior of the model and the process itself. Once conditioned 252, machine learning data analysis process 10 may inference 254 probabilistic model 58 based, at least in part, upon conditioned variable 62 (which may increase the efficiency of the inferencing of probabilistic model 58). As discussed above, this inferencing of probabilistic model 58 may be iterative and recurring in nature. For example, a user (e.g., user 36, 38, 40, 42) may condition 252 a first variable and then probabilistic model 58 may be inferenced 254 based upon this conditioned variable; the user may then condition 252 another variable (or recondition the first variable) and then probabilistic model 58 may be inferenced 254 one again, wherein this conditioning and inferencing process may be repeated by machine learning data analysis process 10 until the desired result is achieved.

Machine learning data analysis process 10 may be configured to monitor the efficiency and progress of the inferencing of (in this example) probabilistic model 58. For example, assume that there are ten variables within probabilistic model 58 that are loading (e.g., bogging down, bimodal, highly multimodal, or ‘confused’ in other ways) the inferencing of probabilistic model 58.

Since machine learning data analysis process 10 can surface variables that are highly bimodal, multimodal, uniform, or “confused” in other ways, machine learning data analysis process 10 may leverage the human's time and effort optimally by only asking the user to condition variables where user input will be maximally effective for guiding inference.

Accordingly, machine learning data analysis process 10 may be configured to identify 256 to the user (e.g., user 36, 38, 40, 42) one or more candidate variables (e.g., candidate variables 64), chosen from the plurality of variables, for potential conditioning selection. Accordingly and continuing with the above-stated example, candidate variables 64 identified 256 by machine learning data analysis process 10 may define these ten variables.

Therefore and when conditioning 252 at least one variable of the plurality of variables (included within probabilistic model 58), machine learning data analysis process 10 may allow 258 the user (e.g., user 36, 38, 40, 42) to select the variable to be conditioned from the variables defined within candidate variables 64, which may restart the inferencing of probabilistic model 58 (and may increase its efficiency) since these variables were identified by machine learning data analysis process 10 as loading (e.g., bogging down) the inferencing of probabilistic model 58.

General

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

Inference Pausing System

What is claimed is:

1. A computer-implemented method, executed on a computing device, comprising:
defining a model that includes a plurality of variables;
conditioning at least one variable of the plurality of variables based, at least in part, upon a conditioning command received from a user, thus defining a conditioned variable; and
inferencing the model based, at least in part, upon the conditioned variable.

2. The computer-implemented method of claim 1 wherein the conditioning command defines a selected value for the at least one variable.

3. The computer-implemented method of claim 1 wherein the conditioning command defines an excluded value for the at least one variable.

4. The computer-implemented method of claim 1 wherein the conditioning command releases control of the at least one variable.

5. The computer-implemented method of claim 1 further comprising:
identifying one or more candidate variables, chosen from the plurality of variables, to the user for potential conditioning selection.

6. The computer-implemented method of claim 5 wherein conditioning at least one variable of the plurality of variables includes:
allowing the user to select the at least one variable from the one or more candidate variables.

7. A computer program product residing on a computer readable medium having a plurality of instructions stored thereon which, when executed by a processor, cause the processor to perform operations comprising:
defining a model that includes a plurality of variables; and
conditioning at least one variable of the plurality of variables based, at least in part, upon a conditioning command received from a user, thus defining a conditioned variable; and
inferencing the model based, at least in part, upon the conditioned variable.

8. The computer program product of claim 7 wherein the conditioning command defines a selected value for the at least one variable.

9. The computer program product of claim 7 wherein the conditioning command defines an excluded value for the at least one variable.

10. The computer program product of claim 7 wherein the conditioning command releases control of the at least one variable.

11. The computer program product of claim 7 further comprising:
identifying one or more candidate variables, chosen from the plurality of variables, to the user for potential conditioning selection.

12. The computer program product of claim 11 wherein conditioning at least one variable of the plurality of variables includes:
allowing the user to select the at least one variable from the one or more candidate variables.

13. A computing system including a processor and memory configured to perform operations comprising:
defining a model that includes a plurality of variables; and
conditioning at least one variable of the plurality of variables based, at least in part, upon a conditioning command received from a user, thus defining a conditioned variable; and
inferencing the model based, at least in part, upon the conditioned variable.

14. The computing system of claim 13 wherein the conditioning command defines a selected value for the at least one variable.

15. The computing system of claim 13 wherein the conditioning command defines an excluded value for the at least one variable.

16. The computing system of claim 13 wherein the conditioning command releases control of the at least one variable.

17. The computing system of claim 13 further configured to perform operations comprising:
identifying one or more candidate variables, chosen from the plurality of variables, to the user for potential conditioning selection.

18. The computing system of claim 17 wherein conditioning at least one variable of the plurality of variables includes:
allowing the user to select the at least one variable from the one or more candidate variables.
